(19) United States
(12) Patent Application Publication
(10) Pub. No.: US 2025/0207024 A1
(43) Pub. Date: Jun. 26, 2025

(54) DARK-COLOURED PHOTOLUMINESCENT MATERIAL

(71) Applicant: The Swatch Group Research and Development Ltd, Marin (CH)

(72) Inventors: Nicolas FRANÇOIS, Neuchâtel (CH); Nathalie Teres, Bôle (CH)

(73) Assignee: The Swatch Group Research and Development Ltd, Marin (CH)

(21) Appl. No.: 18/915,797

(22) Filed: Oct. 15, 2024

(30) Foreign Application Priority Data
Dec. 21, 2023 (EP) 23219378.9

(51) Int. Cl. C09K 11/77; C08K 9/10; C09D 5/22; C09D 7/40; C09D 7/62; C09K 11/02

(52) U.S. Cl. CPC C09K 11/7792; C09D 5/22; C09D 7/62; C09D 7/68; C09D 7/69; C09K 11/025; C08K 9/10; C08K 2201/005

(57) ABSTRACT

A photoluminescent material comprising, by weight, between 19.8% and 54.8% of a polymer matrix, between 45% and 80% of a photoluminescent compound, between 0.2% and 5% of a first dye system and optionally between 0% and 1% of a porous silica, and a second dye system and additives, the total percentage of the second dye system and additives being between 0% and 15%, the first dye system comprising one or more dyes chosen from a trichromy of pigments formed by green pigments, blue pigments and red pigments, and a synthetic black pigment. Also, to an item coated with this photoluminescent material or made as a whole from the photoluminescent material.

### CROSS REFERENCE TO RELATED APPLICATIONS

This application claims priority to European Patent Application No. 23219378.9 filed Dec. 21, 2023, the entire contents of which are incorporated herein by reference.

### TECHNICAL FIELD OF THE INVENTION

The invention relates to a dark-coloured photoluminescent material with optimised luminous performance.

### TECHNOLOGICAL BACKGROUND

Prior art discloses phosphorescent materials made from a mixture of transparent or translucent materials with photoluminescent pigments produced from rare earth-doped mineral oxides. Examples include a mixture of borosilicates with 50% strontium aluminate doped with Europium and Dysprosium (Eu²⁺, Dy³⁺:SrAl₂O₄) or a mixture of acrylic resins with 50% strontium aluminate doped with Europium and Dysprosium. The light decay of these materials is initially exponential. If we start with a luminance of a few tens of Cd/m² for a material placed in the dark after saturation with light energy, the luminance after 10 minutes in the dark will be less than 1 Cd/m². Light decay then tends slowly towards an asymptote at a few mCd/m², which explains why these materials retain a visible luminous persistence in the dark for up to 12 hours. These luminescent materials are essential for the good, passive readability of diving instruments, so progress in terms of luminous performance is sought after.

For aesthetic reasons, these photoluminescent materials can be coloured using a dye system, a mixture of pigments and additives.

Compounds used in photoluminescent materials, including colouring pigments, have been noticed to have a quenching effect on the luminescent properties, the luminance of phosphorescent materials being the result of a physical-chemical interaction between the various compounds of the photoluminescent material.

It is therefore difficult to jointly optimise colouration and luminous properties. For black colours, and dark colours in general, tests were carried out with various carbon blacks. It was found that these absorbed too much in the absorption and emission range of the phosphorescent pigment, which had an impact on the material's luminous performance. An optimum must thus always be found between colour and photoluminescence.

### SUMMARY OF THE INVENTION

The invention consists of a novel formulation making it possible to obtain a beautiful black colour in daylight and, in general, beautiful dark colours in daylight, while at the same time having good luminescent properties.

For this purpose, the invention proposes adding to the formulation either a mixture of pigments which is a trichromy of three primary colours which are red, green and blue, or a synthetic black pigment of the C.I Solvent Black 27, Brilliant Black BN or Perylene Black type, or a combination of the pigment trichromy and the synthetic black pigment. The formulation can comprise a trichromy of the three primary colours to obtain the dark colour, with the colour then being adjusted by adding the synthetic black pigment. Alternatively, the colour could be adjusted by adding a small amount of carbon black. In another embodiment, the formulation comprises only the synthetic black pigment, optionally with a small amount of carbon black, to obtain the black colour with good phosphorescent intensity.

Optionally, the photoluminescent material further comprises porous silica derived from algae to increase the luminous properties. The porous silica is derived from diatom skeletons. These are microalgae that are unicellular organisms with a silica skeleton. More specifically, according to the latest biological research, diatoms, the single-celled algae that make up plankton, are made up of silica nanocells that are highly efficient at absorbing daylight, even in the dark depths of the oceans, so that they can carry out photosynthesis efficiently. Adding a limited percentage of porous silica, with contents of less than or equal to one percent by mass, to the photoluminescent material improves the luminescence properties.

More specifically, the invention relates to a photoluminescent material comprising, by weight, between 19.8% and 54.8% of a polymer matrix, between 45% and 80% of a photoluminescent compound, between 0.2% and 5% of a first dye system and optionally between 0% and 1% of a porous silica, and a second dye system and additives, the total percentage of the second dye system and additives being between 0% and 15%, the first dye system comprising one or more dyes chosen from a trichromy of pigments formed by green pigments, blue pigments and red pigments, and a synthetic black pigment.

The invention further relates to the item produced as a whole from this photoluminescent material or coated with this photoluminescent material.

### DETAILED DESCRIPTION OF THE INVENTION

The invention relates to a dark-coloured photoluminescent material which can be used to produce, as a whole, an item or to coat an item. The item can, for example, be a timepiece component. More specifically, it can be an external component chosen from the non-exhaustive list that includes a middle, a back, a bezel, a crown, a push-piece, a bracelet link, a bracelet, a tongue buckle, a clasp, a dial, a flange, a date disc, a hand and a dial index.

The photoluminescent material comprises (consists of) a polymer matrix, a photoluminescent compound, a first dye system and optionally a porous silica, additives and a second dye system.

The first dye system, which constitutes the more specific subject matter of the invention, comprises one or more of the dyes chosen from the trichromy formed by red, green and blue primary pigments, and the synthetic black pigment which is preferably solvent black 27, perylene black and/or brilliant black BN. The first dye system is present in a weight percentage of between 0.2% and 5%, preferably between 0.3% and 4%, and more preferably between 0.4% and 2%.

For example, red primary pigments can be of the carmine (a lacquer pigment derived from cochineal), azo, quinacridone or perylene type. Green primary pigments can be of the phthalocyanine or naphthol type and blue primary pigments can be of the anthraquinone, phthalocyanine or perylene type. Solvent black 27 has the formula C₁₇H₁₃N₃O₄Cr_{1/2}. For example, it is marketed under the brand name Polysynthren® Black H. Brilliant black BN, also referred to as Black PN, is a dye of the azo family and has the formula C₂₈H₁₇N₅Na₄O₁₄S₄. It can, for example, be obtained under the brand name NOIR BRILLANT BN 80% E151 by Sensient Cosmetic Technologies. A person skilled in the art can also use perylene black.

According to a first alternative embodiment, the first dye system comprises (consists of) the trichromy of pigments only. For this alternative embodiment, the percentage of the trichromy based on the total weight of the photoluminescent material is between 0.5% and 4%, preferably between 0.7% and 2%. Preferably, the three pigments are present in the same percentage. For example, if the trichromy of pigments is added to 1.5%, each pigment is added in a proportion of 0.5% of the total weight. This equal proportion could be disregarded by using a proportion of between 20% and 40% for each pigment. According to a second alternative embodiment, the first dye system comprises (consists of), on the one hand, the trichromy of pigments and, on the other hand, the synthetic black pigment with between 0.2% and 3%, preferably between 0.4% and 1.5%, and more preferably between 0.4% and 1% of the trichromy of pigments based on the total weight of the photoluminescent material, and between 0.01% and 1%, preferably between 0.02% and 0.5%, and more preferably between 0.02% and 0.2% of synthetic black pigment based on the total weight of the photoluminescent material. According to a third alternative embodiment, the first dye system comprises only the synthetic black pigment, comprising between 0.2% and 2%, preferably between 0.3% and 1.5%, and more preferably between 0.3% and 1% thereof, based on the total weight of the photoluminescent material.

The polymer matrix is present in a weight percentage of between 19.8% and 54.8%, preferably between 29.7% and 49.7%, and more preferably between 34.6% and 44.6%. It should be noted that the upper limit for the polymer matrix is calculated for a photoluminescent material without porous silica, without a second dye system and without additives. In the presence of one of these compounds, the maximum limit will be reduced accordingly so as not to exceed a percentage of 100% for all of the compounds in the photoluminescent material. In the case of the polymer matrix, this can be any polymer that is transparent or semi-transparent in the visible range. By way of example, it can be one or more of the following polymers: resins from the acrylic family, the polyamide family, the polyolefin family, the epoxy family, the polyurethane family, the fluoroelastomer family and silicones.

The photoluminescent compound is present in a weight percentage of between 45% and 80%, preferably between 50% and 70%, and more preferably between 55% and 65%. The photoluminescent compound can consist of a pigment or a pigment encapsulated in a transparent shell. The pigment is preferably a rare earth-doped alkaline earth aluminate derivative. More specifically, the pigment can be Europium and Dysprosium doped strontium aluminate with the formula Sr(x)Al(y)O(z): Eu²⁺,Dy³⁺. In particular, this can be Sr₄Al₁₄O₂₅: Eu²⁺,Dy³⁺ or SrAl₂O₄: Eu²⁺,Dy³⁺, optionally both present in the photoluminescent compound. Advantageously, the pigments can have different particle sizes to allow the pigments to be distributed optimally in the volume and avoid free spaces. The presence of different particle sizes in the volume also makes it possible to combine small particles forming shallow surface traps responsible for high light intensity over short periods with large particles forming deeper traps responsible for light remanence over long periods. By way of example, the pigments can have a first particle size range centred around a diameter D1 of between 500 nm and 10 μm, ideally between 500 nm and 5 μm, and a second particle size range centred around a diameter D2 of between 10 μm and 500 μm, ideally between 10 μm and 20 μm, with the particle size measured by laser particle size analysis to ISO 13320:2020, optionally supplemented by SEM analysis using secondary electron imaging. It should be noted that more than two particle size fractions can be sieved and then combined. For example, it is possible to have a 20 wt % of a first fraction between 500 nm and 5 μm, 60 wt % of a second fraction between 5 μm and 20 μm, and 20 wt % of a third fraction between 20 μm and 50 μm.

The pigments can optionally be encapsulated in a transparent organic or mineral shell. The organic shell can typically be chosen from the polymers mentioned for the polymer matrix. A mineral shell could, for example, be a silica (SiO₂) shell obtained, for example, using a sol-gel process. Other examples of mineral shells include zirconium oxide (ZrO₂), and aluminium oxide (Al₂O₃), etc.

The photoluminescent material optionally further comprises a total of between 0 wt % and 15 wt %, preferably between 0 wt % and 5 wt % of a second dye system and additives. Advantageously, it comprises between 0.5 wt % and 5 wt % of the second dye system and additives. The second dye system preferably comprises organic dyes which do not absorb in the emission wavelength ranges of the photoluminescent pigment. These can be fluorescent pigments or dyes whose absorption is more in the UV range and whose emission is in the visible spectrum. Examples include organic fluorescent pigments or dyes such as those by Radiant or Aralon®. They can also be translucent pigments or dyes with low absorption in the emission wavelengths of the phosphorescent pigment. Examples include translucent pigments or dyes by Clariant. The second dye system can also include carbon black to adjust the dark colour. The percentage of carbon black is between 0% and 1%, preferably no more than 0.5% or even no more than 0.3%. If carbon black is present, the lower limit is 0.01%. The percentage of carbon black is thus between 0.01% and 1%, preferably between 0.01% and 0.5%, and more preferably between 0.01% and 0.3%.

Other additives can be added, such as metallic and pearlescent effect pigments, anti-UV additives to protect the polymer matrix, a dispersant such as silane to facilitate dispersion of the additives and a nanometric filler of the silica type to adapt the viscosity parameters of the mixture, etc.

Optionally, the photoluminescent material can comprise porous silica derived from diatom skeletons. Typically, the average pore diameter can be in the order of 500 nm. Optionally, it could be a synthetic porous silica. For a synthetic silica, pores typically have an average diameter of between 0.1 μm and 3 μm. The porous silica is present in a percentage by weight of between 0% and 1%, preferably between 0.01% and 1%, more preferably between 0.07% and 0.3%, and even more preferably between 0.09% and 0.2%.

The method for manufacturing an item produced as a whole from the photoluminescent material involves mixing the one or more polymers intended to form the polymer matrix with, preferably, a dispersant. This initial mixing is carried out with the photoluminescent pigments, which optionally may have been encapsulated beforehand. The first dye system is then added to this second mixture, along with any second dye system, additives and porous silica. The mixtures can be made either from liquid resins using a speed-mixer or a paddle mixer. The resulting mixture can then be shaped by extrusion. The mixtures can also be made in a twin-screw extruder or in a high-speed mixer for the manufacture of thermoplastic mixtures and transformation into granules, which can be reused for injection moulding.

The method for manufacturing an item coated with the photoluminescent material consists of depositing a coating on the substrate using techniques such as screen printing, pad printing or spray coating.

Tests to produce samples, as a whole, with the photoluminescent material were carried out by adding a dye system comprising the trichromy of primary colours and black solvent 27 to an epoxy resin with a filler content of 60% by weight of photoluminescent pigments of Eu²⁺,Dy³⁺:SrAl₂O₃. The percentage by weight of the three primary colours was 0.6% with the same distribution for each colour and the percentage of black solvent 27 was 0.05% by weight. Tests were also carried out using the same base material and black solvent 27 as the dye system at a percentage of 0.4% of the total weight. Tests were also carried out with the same base material and the trichromy of primary colours as the dye system at a total percentage by weight, based on the total weight, of 1.5% and with a percentage of 0.5% for each colour.

Tests were also carried out with an additional 0.2% porous silica.

The samples were observed under a D65 light booth. At the same time, comparative tests were carried out with various black pigments, including carbon black with different particle sizes and structures, or minerals such as iron III oxides (Fe₃O₄) with the same base material.

The material was shaped by vacuum casting.

With mineral oxides, the luminescent material is extinguished fairly quickly. With carbon black, the colours are quite dark, but when used alone, the loss of luminance is too great. Tests with the trichromy alone, solvent black 27 alone and the two combined produced a satisfactory colour in daylight and a 15% improvement in luminous performance. Tests with porous silica showed a 20% increase in luminescence properties after 10 minutes, with the luminescence properties being measured in accordance with ISO 17514-2003.

1. A photoluminescent material comprising, by weight, between 19.8% and 54.8% of a polymer matrix, between 45% and 80% of a photoluminescent compound, between 0.2% and 5% of a first dye system and between 0% and 1% of a porous silica, and a second dye system and additives, the total percentage of the second dye system and additives being between 0% and 15%, the first dye system comprising one or more dyes chosen from a trichromy of pigments formed by green pigments, blue pigments and red pigments, and a synthetic black pigment.

2. The photoluminescent material according to claim 1, wherein the synthetic black pigment is a solvent black 27, a brilliant black BN, a perylene black or a combination of the three.

3. The photoluminescent material according to claim 1, wherein the polymer matrix is present in a percentage of between 29.7% and 49.7%, the photoluminescent compound is present in a percentage of between 50% and 70%, and the first dye system is present in a percentage of between 0.3% and 4%.

4. The photoluminescent material according to claim 1, wherein the polymer matrix is present in a percentage of between 34.6% and 44.6%, the photoluminescent compound is present in a percentage of between 55% and 65%, and the first dye system is present in a percentage of between 0.4% and 2%.

5. The photoluminescent material according to claim 1, wherein the first dye system consists of between 0.5 wt % and 4 wt % of the trichromy of pigments.

6. The photoluminescent material according to claim 1, wherein the first dye system consists of the trichromy of pigments and synthetic black pigment, with between 0.2% and 3% of the trichromy of pigments, and between 0.01% and 1% of the synthetic black pigment, based on the total weight of the photoluminescent material.

7. The photoluminescent material according to claim 1, wherein the respective proportion of green pigments, blue pigments and red pigments is between 20% and 40% of the total weight of the trichromy of pigments.

8. The photoluminescent material according to the claim 7, wherein the green pigments, blue pigments and red pigments are present in the trichromy of pigments in the same proportion.

9. The photoluminescent material according to claim 1, wherein the first dye system consists of between 0.2% and 2% of the synthetic black pigment.

10. The photoluminescent material according to claim 1, wherein the second dye system comprises carbon black, with between 0.01% and 1% thereof, based on the total weight of the photoluminescent material.

11. The photoluminescent material according to claim 1, wherein the porous silica is present in a percentage of between 0.01% and 1%.

12. The photoluminescent material according to claim 1, wherein the porous silica is derived from diatom skeletons.

13. The photoluminescent material according to claim 1, wherein the photoluminescent compound comprises a pigment which is a rare earth-doped alkaline earth aluminate derivative.

14. The photoluminescent material according to claim 13, wherein the pigment is a Europium- and Dysprosium-doped alkaline-earth aluminate derivative of the formula Sr(x)Al(y)O(z): Eu²⁺,Dy³⁺.

15. The photoluminescent material according to claim 14, wherein the pigment is Sr₄Al₁₄O₂₅: Eu²⁺,Dy³⁺ and/or SrAl₂O₄: Eu²⁺,Dy³.

16. The photoluminescent material according to claim 13, wherein the photoluminescent compound consists of said pigment encapsulated in an organic or mineral, transparent shell.

17. The photoluminescent material according to claim 1, wherein the polymer matrix comprises one or more resins from the acrylic family, the polyamide family, the polyolefin family, the epoxy family, the polyurethane family, the fluoroelastomer family and silicones.

18. The photoluminescent material according to claim 16, wherein the organic transparent shell comprises one or more resins from the acrylic family, the polyamide family, the polyolefin family, the epoxy family, the polyurethane family, the fluoroelastomer family and silicones, and wherein the mineral transparent shell comprises silica.

19. The photoluminescent material according to claim 13, wherein the photoluminescent compound comprises pigments of various particle sizes.

20. The photoluminescent material according to claim 19, wherein the pigments have at least a first particle size range centred around a diameter D1 of between 500 nm and 10 μm and a second particle size range centred around a diameter D2 of between 10 μm and 500 μm.

21. An item produced from or coated with said photoluminescent material according to claim 1.

22. The item according to claim 21, wherein the item is a timepiece component.
